(19) United States
(12) Patent Application Publication
(10) Pub. No.: US 2026/0087046 A1
(43) Pub. Date: Mar. 26, 2026

(54) LARGE LANGUAGE MODEL-BASED QUESTION ANSWERING METHOD

(71) Applicant: BEIJING BAIDU NETCOM SCIENCE TECHNOLOGY CO., LTD., BEIJING (CN)

(72) Inventors: Jingbo ZHOU, BEIJING (CN); Pengfei LUO, BEIJING (CN)

(73) Assignee: BEIJING BAIDU NETCOM SCIENCE TECHNOLOGY CO., LTD., BEIJING (CN)

(21) Appl. No.: 19/406,752

(22) Filed: Dec. 2, 2025

(30) Foreign Application Priority Data
Sep. 19, 2025 (CN) 202511349779.2

(51) Int. Cl. G06F 16/3329; G06F 16/3332; G06F 16/334

(52) U.S. Cl. CPC G06F 16/33295; G06F 16/3338; G06F 16/3347

(57) ABSTRACT

A method includes: obtaining a document comprising at least one page for question answering; determining a first vector corresponding to each of the at least one page; determining a second vector corresponding to a target question text to be answered; performing the following first operations: determining, based on the second vector and the first vector corresponding to each of the at least one page, a first similarity between the target question text and each of the at least one page; determining, based on the first similarities, at least one candidate page with the highest similarity to the target question text among the at least one page; and generating, based on the at least one candidate page and the target question text, a first identifier and first content, or second identifier and second content, using a large language model.

### CROSS REFERENCE TO RELATED APPLICATION

This application claims priority to Chinese patent application No. 202511349779.2 filed on Sep. 19, 2025, the contents of which are hereby incorporated by reference in their entirety for all purposes.

### TECHNICAL FIELD

The present disclosure relates to the field of artificial intelligence, particularly to the technical fields of intelligent search, natural language processing, and large model, and specifically to a large model based question answering method, apparatus, electronic device, computer-readable storage medium, and computer program product.

### BACKGROUND

Artificial intelligence is the discipline of studying how computers can simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc. The artificial intelligence software technologies mainly include computer vision technology, speech recognition technology, natural language processing technology, machine learning/deep learning, big data processing technology, knowledge graph technology and other major technological directions.

Human-machine interaction is a way of human interaction with a machine using natural language. With the continuous development of artificial intelligence technology, it has been realized that the machine is able to understand information output by a human, comprehend the inherent meaning within the information, and provide corresponding feedback. In these operations, the accurate understanding of semantics, the degree of rapid feedback, and the provision of relevant opinions or suggestions all become factors affecting the smoothness of human-machine interaction.

The methods described in the section are not necessarily methods that have been previously conceived or employed. Unless otherwise indicated, it should not be assumed that any method described in the section is considered to be the prior art only due to its inclusion in the section. Similarly, the problems mentioned in the section should not be assumed to be recognized in any prior art unless otherwise indicated.

### SUMMARY

The present disclosure provides a large model-based question answering method, an apparatus, an electronic device, a computer-readable storage medium, and a computer program product.

According to one aspect of the present disclosure, a large model-based question answering method is provided, including: obtaining a document for question answering, wherein the document includes at least one page; determining a first vector corresponding to each of the at least one page; obtaining a target question text to be answered to determine a second vector corresponding to the target question text; performing the following first operations on the target question text: determining, based on the second vector and the first vector corresponding to each of the at least one page, a first similarity between the target question text and each of the at least one page; determining, based on the first similarities, at least one candidate page with the highest similarity to the target question text among the at least one page; and generating, based on at least one candidate page and the target question text, a first identifier and first content, or generating a second identifier and second content, using a large language model. wherein the first content includes an answer corresponding to the target question text, wherein the answer is generated based on the at least one candidate page, and the first identifier is used to identify that the content within the at least one candidate page is sufficient to answer the target question text; wherein the second content includes at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, and wherein the at least two sub-question texts are used to obtain the answer to the target question text.

According to another aspect of the present disclosure, an electronic device is provided. The electronic device includes: a memory storing one or more programs configured to be executed by one or more processors, the one or more programs including instructions for performing operations comprising: obtaining a document for question answering, wherein the document comprises at least one page; determining a first vector corresponding to each of the at least one page; obtaining a target question text to be answered to determine a second vector corresponding to the target question text; performing the following first operations on the target question text: determining, based on the second vector and the first vector corresponding to each of the at least one page, a first similarity between the target question text and each of the at least one page; determining, based on the first similarities, at least one candidate page with the highest similarity to the target question text among the at least one page; and generating, based on the at least one candidate page and the target question text, a first identifier and first content, or generating a second identifier and second content, using a large language model, wherein the first content comprises an answer corresponding to the target question text, wherein the answer is generated based on the at least one candidate page, and the first identifier is used to identify that the content within the at least one candidate page is sufficient to answer the target question text; wherein the second content comprises at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, wherein the at least two sub-question texts are used to obtain the answer to the target question text.

According to another aspect of the present disclosure, a non-transitory computer-readable storage medium storing computer instructions is provided, wherein the computer instructions are used to enable the computer to perform the following operations: obtaining a document for question answering, wherein the document comprises at least one page; determining a first vector corresponding to each of the at least one page; obtaining a target question text to be answered to determine a second vector corresponding to the target question text; performing the following first operations on the target question text: determining, based on the second vector and the first vector corresponding to each of the at least one page, a first similarity between the target question text and each of the at least one page; determining, based on the first similarities, at least one candidate page with the highest similarity to the target question text among the at least one page; and generating, based on the at least one candidate page and the target question text, a first identifier and first content, or generating a second identifier and second content, using a large language model, wherein the first content comprises an answer corresponding to the target question text, wherein the answer is generated based on the at least one candidate page, and the first identifier is used to identify that the content within the at least one candidate page is sufficient to answer the target question text; wherein the second content comprises at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, wherein the at least two sub-question texts are used to obtain the answer to the target question text.

It should be understood that the content described in the section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The drawings exemplarily illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein can be implemented according to embodiments of the present disclosure;

FIG. 2 illustrates a flowchart of a large model-based question answering method according to an embodiment of the present disclosure;

FIG. 3 illustrates a schematic diagram of an inference tree for question answering according to an embodiment of the present disclosure;

FIG. 4 illustrates a structural block diagram of a large model-based question answering apparatus according to an embodiment of the present disclosure; and

FIG. 5 illustrates a structural block diagram of an example electronic device that may be used to implement embodiments of the present disclosure.

### DETAILED DESCRIPTION OF THE EMBODIMENTS

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first second” and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

Embodiments of the present disclosure will be described in detail below with reference to the accompanying drawings.

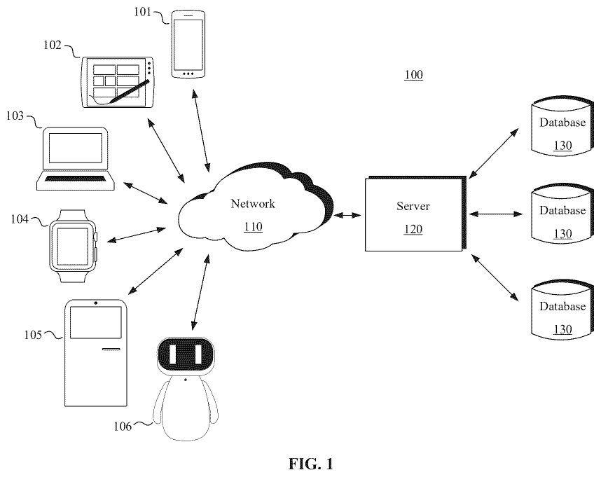

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105 and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of the large model based question answering method.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to input a question, determine a document, and receive an answer. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple iOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and 106. The server 130 may also include one or more applications to display the data feeds and/or the real-time events via one or more display devices of the client devices 101, 102, 103, 104, 105, and 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in a cloud computing service system to overcome the defects of management difficulty and weak service expansibility exiting in a traditional physical host and virtual private server (VPS) service.

The system 100 may also include one or more databases 130. In certain embodiments, these databases may be used to store data and other information. For example, one or more of the databases 130 may be used to store information such as documents and context. The databases 130 may reside in various locations. For example, the database used by the server 120 may be local to the server 120, or may be remote from the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

In the field of document processing and retrieval-augmented generation, a multimodal document-based question answering task requires the ability to comprehensively utilize multimodal information within a document, such as text, images, and tables, to provide users with more comprehensive and precise content understanding and retrieval service.

Typically, a single process document question answering method uses page content as a retrieval object, searches the most relevant page segments according to the user question and generates an answer based on these segments. The general approach is to first convert the page content into two forms of text and images, then to respectively recall relevant paragraphs or images from text and image perspectives by combining the question issued by the user, subsequently utilize a large language model or a multimodal model to process, and finally consolidate and generate an answer. However, the linear process exhibits shortcomings in robustness and the consistency of multimodal question answering. An alternative approach may employ iterative retrieval, that is, each iteration attempts to answer a part of the question based on the retrieval result, and then perform a new retrieval on unresolved parts until a complete answer is obtained. However, the method does not explicitly model the subdivision and segmentation of the question, leading to insufficient planning for sub-questions, ultimately resulting in weaker answer relevance and susceptibility to introducing additional errors during inference.

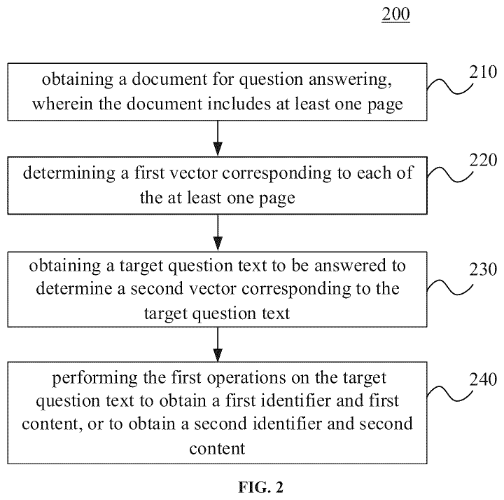

Therefore, a large model-based question answering method is proposed according to embodiments of the present disclosure. FIG. 2 illustrates a flowchart of a large model-based question answering method according to an embodiment of the present disclosure. As shown in FIG. 2, the method 200 includes: obtaining a document for question answering, wherein the document includes at least one page (step 210); determining a first vector corresponding to each of the at least one page (step 220); obtaining a target question text to be answered to determine a second vector corresponding to the target question text (step 230); performing the following first operations on the target question text to obtain a first identifier and first content, or to obtain a second identifier and second content (step 240).

In some embodiments of the present disclosure, the first operations includes: determining, based on the second vector and the first vector corresponding to each of the at least one page, a first similarity between the target question text and each of the at least one page; determining, based on the first similarities, at least one candidate page with the highest similarity to the target question text among the at least one page; and generating, based on at least one candidate page and the target question text, a first identifier and first content, or generating a second identifier and second content, using a large language model.

In the embodiments of the present disclosure, the first content includes the answer corresponding to the target question text, wherein the answer is generated based on the at least one candidate page. The first identifier is used to identify that the content within the at least one candidate page is sufficient to answer the target question text. The second content includes at least two sub-question texts corresponding to the target question text, the at least two sub-question texts respectively correspond to sub-steps for answering the target question text, and the at least two sub-question texts are used to obtain the answer to the target question text. The second identifier is used to identify that the content within the at least one candidate page is insufficient to answer the target question text.

According to the embodiments of the present disclosure, a tree inference-based document question answering method is implemented. Specifically, after obtaining a candidate page for answering a target question through preliminary filtering, a large language model is used to determine whether to directly answer the target question or further segment the target question into a plurality of sub-questions. Consequently, this enables a recursive, layered implementation of the document question answering process. This approach addresses the shortcomings of single-process approaches in terms of robustness, consistency, and insufficient reasoning capabilities, and significantly improving the robustness and stability of document question answering process.

In some embodiments, the target question text may be input by the user via text, voice, images, or other forms. For example, when inputting via voice, the voice may be converted into text using a speech recognition technology to obtain the target question text.

In some embodiments, in step 220, the first vector corresponding to each of the at least one page may be determined based on the page image of the at least one page.

By directly leveraging page images to enable filtering of subsequent candidate pages and then obtaining the answer to the target text without converting text or images respectively, or performing optical character recognition using additional models to extract page text, the resource consumption in additional system construction can be reduced and extra operational steps can be minimized, thereby enhancing both operational efficiency and effectiveness.

According to some embodiments, determining the first vector corresponding to each of the at least one page includes: for each of the at least one page, inputting the page image of the page into a pre-trained vision and language model to obtain the first vector corresponding to the page.

A vision and language model (VLM) is a multimodal neural network model capable of simultaneously processing image and text data. Its core task involves, through cross-modal representation learning, understanding and generating language information related to visual content, or generating corresponding visual content from language information. Compared to a traditional single-modal model, the advantage of the vision and language model is that it can perform multifaceted inference and generation by integrating visual and language information.

For example, in the embodiments of the present disclosure, visual language models such as CLIP (Contrastive Language-Image Pretraining) and BLIP (Bootstrapping Language-Image Pre-training) may be employed. CLIP, proposed by OpenAI, is a visual language model designed to combine visual and language information in the same feature space through contrastive learning. The model achieves a significant result in a plurality of computer vision and natural language processing tasks. The core advantage is that pre-training is performed on a large number of unlabeled data in a contrastive learning manner, so that the model has a very strong migration capability in a plurality of downstream tasks. BLIP is a novel visual language model that is pre-trained in a self-supervised manner to better handle visual-language tasks. The BLIP pre-trains the image and the text by a self-supervised learning method, thereby improving the performance and versatility of the model.

Accordingly, according to some embodiments, obtaining the target question text to be answered to determine the second vector corresponding to the target question text includes: inputting the target question text into a pre-trained visual language model to obtain the second vector corresponding to the target question text.

According to some embodiments, the first vector is a first vector matrix, each row or column of the first vector matrix serves as a third vector respectively, and each third vector is used to represent at least a part of the page content within the page.

As described above, the first vector corresponding to the page may be obtained by inputting the page image of the corresponding page into the pre-trained visual-language model. At the point, in some embodiments, the first vector output by the visual-language model may be the first vector matrix, and each row or column of the first vector matrix respectively serves as the third vector for representing at least a part of the page content of the page.

According to some embodiments, determining the first vector corresponding to each of the at least one page may include: for each of the at least one page, performing the following operations: segmenting the page into a plurality of page blocks, wherein each of the plurality of page blocks corresponds to at least a part of the page content within the page; and determining, for each page block, a third vector corresponding to the page block to generate the first vector corresponding to the page based on the third vectors corresponding to the plurality of page blocks.

In the above embodiment, different from directly generating a set of vectors of each page using a visual language model, each page may first be segmented into a plurality of page blocks, with each block corresponding to a part of content within the page. Then, for each page block, the third vector corresponding to the page block is obtained. The third vectors corresponding to all the page blocks of the respective page are combined, such as by treating each third vector as a row or column in a vector matrix, to obtain the first vector corresponding to the page.

In the above embodiment, a page may be segmented using any suitable method to obtain a plurality of page blocks. For example, segmentation may be performed based on text paragraphs. Alternatively, when the page contains both images and text, each image may be treated as a page block, and the text may be further segmented into a plurality of page blocks based on paragraphs and the like, which is not limited herein.

For example, for document

$$D = {\{ {p}_{i} \}}_{i = 1}^{N} ,$$

there are N pages (where N is a positive integer) included in the document, pᵢ is the i^{th} page of document D. For example, as described above, for the document including a series of pages

$${\{ {p}_{i} \}}_{i = 1}^{N} ,$$

the page images of each page of the document may be converted into a set of vectors using a pre-trained visual-language model, thereby obtaining the first vector matrix.

For example, for page pᵢ, the generated first vector may be represented as follows:

$${E}_{i} = \{ {e}_{i 1} , {e}_{i 2} , … , {e}_{i n} \} = V L M ( {p}_{i} )$$

where, eᵢⱼ∈R^{d} denotes one third vector, with the length of d, corresponding to certain part (e.g., the j^{th} page block) of the page content of the i^{th} page. Eᵢ∈R^{n×d} denotes the first vector matrix of the i^{th} page object within the document, where n denotes the number of third vectors generated based on the i^{th} page, such as the number of page blocks obtained after performing content segmentation on the page.

For other pages in the document, the same vectorization encoding operation may also be performed according to the above method to obtain

$${\{ {E}_{i} \}}_{i = 1}^{N} ,$$

representing the vectorized encoding of document D, i.e., a set of first vectors. The set of first vectors may be used to retrieve candidate pages relevant to the target question text.

Therefore, according to some embodiments, determining, based on the second vector and the first vector, the first similarity between the target question text and each of the at least one page may include: for each of the at least one page, determining, among all third vectors corresponding to the page, the third vector with the highest similarity to the second vector, and determining a second similarity between the third vector with the highest similarity and the second vector, to determine the first similarity between the target question text and each of the at least one page based on the second similarity.

Specifically, in some examples, for the second vector and the i^{th} page in document D, similarity calculations may be performed between the second vector and each third vector (eᵢ₁, eᵢ₂, . . . , eᵢₙ) in Eᵢ corresponding to the i^{th} page to determine the third vector eᵢₖ with the highest similarity to the second vector, i.e. the similarity between the third vectoreᵢₖ and the second vector is the second similarity. Then, the first similarity between the target question text and the i^{th} page is determined based on the second similarity, for example, the second similarity is used as the first similarity.

When a page contains extensive or scattered content, the differences between pages may be insignificant when directly calculating the similarity between the question text and the entire page. Through the above implementation, a local vector that is closest to the question text is determined, thereby identifying the most relevant local area content and enhancing the accuracy and efficiency of subsequently generated answer.

According to some embodiments, the second vector is a second vector matrix, wherein each row or column of the second vector matrix serves as a fourth vector, with each fourth vector is used to represent at least a part of the text content in the target question text.

As described above, the second vector corresponding to the target question text may be obtained by inputting the target question text into a pre-trained visual language model. At the point, in some embodiments, the second vector output by the visual language model may be a second vector matrix, with each row or column of the second vector matrix serves as a fourth vector for representing at least a part of the text content within the target question text, such as the corresponding character or word in the target question text.

According to some embodiments, obtaining the target question text to be answered to determine the second vector corresponding to the target question text includes: performing word segmentation on the target question text to obtain a plurality of words corresponding to the target question text; determining a fourth vector corresponding to each of the plurality of words to generate the second vector corresponding to the target question text based on the fourth vectors corresponding to the plurality of words.

In the above embodiment, different from directly generating a set of vectors for the target question text using a visual language model, the target question text may first undergo word segmentation to obtain a plurality of words corresponding to the target question text. Here, the plurality of words obtained by word segmentation may include individual characters, such as a single character or punctuation mark in Chinese text.

Then, for each word, the fourth vector corresponding to the word is obtained. The fourth vectors corresponding to all words in the target question text are combined, for example, by treating each fourth vector as a row or column of a vector matrix, to obtain the second vector corresponding to the target question text.

In the above embodiment, word segmentation may be performed on the target question text using any suitable method to obtain the plurality of words. Examples include semantic analysis-based, dictionary-based word segmentation algorithms, statistic-based word segmentation algorithms, etc., which is not limited herein.

For example, for a target question text q, as described above, a pre-trained visual-language model may be used to convert the target question text into a set of vectors, that is to obtain the second vector matrix.

For example, for the target question text q, the generated second vector may be represented as follows:

$$F = \{ {f}_{1} , {f}_{2} , … , {f}_{m} \} = VLM ( q )$$

where fⱼ∈R^{d} denotes the j^{th} fourth vector, with a length of d, corresponding to the target question text, and F∈R^{m×d} denotes the second vector matrix corresponding to the target question text, where in denotes the number of fourth vectors therein, for example, the number of words obtained after performing word segmentation on the target question text.

Therefore, according to some embodiments, determining, based on the second vector and the first vector, the first similarity between the target question text and each of at least one page includes: for each fourth vector in the second vector matrix, determining, among all the third vectors, the third vector with the highest similarity to the fourth vector, and a third similarity between the third vector with the highest similarity and the fourth vector; and determining, based on the third similarity corresponding to each of the fourth vectors, the first similarity between the target question text and each of the at least one page.

Specifically, in some examples, when receiving a question text (either an original question or any sub-question), the question text needs to be vectorized to perform similarity calculation on the vectorized representation of the question text and each page in the document, thereby identifying the page that is most relevant to the question. To better preserve the fine-grained semantic matching relationship between the question and local region of the page, a late interaction mechanism may be employed.

For example, on the basis of obtaining the first vector Eᵢ of the i^{th} page pᵢ and the second vector F of the target question text q, for each fourth vector fⱼ in the second vector F, identifying the third vector eᵢₖ, among the first vector Eᵢ of the page, with the highest similarity to the fourth vector fⱼ. Then, determining, based on the third similarity corresponding to each of the fourth vectors, the first similarity between the target question text and each of the at least one page.

For example, determining, among all third vectors corresponding to the i^{th} page pᵢ, the third vector eᵢₖ with the highest similarity to the fourth vector fⱼ corresponding to the target question text:

$${s}_{j} ( {p}_{i} ) = {max}_{k} sim ( {f}_{{j}^{}} , {e}_{ik} ) ,$$

where, sim(fⱼ, eᵢₖ) denotes the inner product of vectors, and sᵢ(pᵢ) denotes the similarity between the fourth vector fⱼ and the third vector eᵢₖ. Next, accumulating the maximum similarities corresponding to all fourth vectors of the target question text to obtain the first similarity S(q, pᵢ) between the target question text q and the i^{th} page pᵢ:

$$S ( q , {p}_{i} ) = {\sum }_{j = 1}^{m} {s}_{j} ( {p}_{i} ) = {\sum }_{j = 1}^{m} {max}_{k} sim ( {f}_{{j}^{}} , {e}_{ik} )$$

In the way, the similarity between the question and the corresponding page not only relies on the overall semantic representation but also preserves fine-grained matching relationships, thereby ensuring that the most relevant local region content for each key component of the question can be identified in the page. Consequently, both efficiency and accuracy are achieved, thereby enhancing the precision and efficiency of subsequently generated question answers.

Finally, all pages of document D may be sorted based on their first similarities S(q, pᵢ) to obtain a set of candidate pages:

$$Rank ( q , D ) = sort ( \{ S ( q , {p}_{1} ) , … , S ( q , {p}_{N} \}$$

where, the top several pages in the sorting result may serve as candidate pages for subsequent further processing based on large language models.

Specifically, after identifying at least one candidate page, the first identifier and first content, or alternatively the second identifier and second content may be generated using a large language model based on the at least one candidate page and the target question text.

In some embodiments, the large language model may be a knowledge-enhanced large language model for conversation (e.g., ERNIE bot), and the large language model is trained using massive knowledge resources and conversation data (e.g., including over trillions of web pages, billions of search queries, hundreds of millions of images, billions of daily voice requests, over 50 billion text requests, and over 550 billion factual knowledge entries).

Consequently, applying such model as the aforementioned large language model enables not only direct processing of casual conversation information but also direct generation of response information for conversation information such as logical inference, common sense, image generation, and question answering, thereby further improving the generation efficiency while generating higher quality response information.

In some examples, corresponding text data may be extracted from the candidate pages, and then the extracted text data, along with the target question text, is input into the large language model to obtain the corresponding result.

In some embodiments, the large language model may be a multimodal large language model (MLLM). That is, after obtaining the question and retrieving the most relevant candidate pages, the multimodal large language model (MLLM) may be invoked to attempt to answer the question. That is, the page image corresponding to each of the at least one candidate page may be input, along with the target question text, into the multimodal large language model to obtain the corresponding result. Alternatively, the corresponding text data and image data may be extracted from the candidate pages, and then the extracted text data and image data may be input, along with the target question text, into the multimodal large language model to obtain the corresponding result. The multimodal large language model may simultaneously receive multimodal input information, thereby enabling cross-modal result inference and generation.

In the embodiments of the disclosure, the large language model-based result inference and generation process may include two types of scenarios:
scenario (1), it is determined that the question can be answered: when the large language model determines that the content in the currently determined at least one candidate page is sufficient to answer the target question text, that is, the at least one candidate page has already contained adequate information, and the output result of the large language model is the first identifier and first content. As described above, the first identifier is used to identify that the content in the at least one candidate page is sufficient to answer the target question text. The first content includes the answer corresponding to the target question text, and the answer is generated based on the at least one candidate page.
scenario (2), it is determined that the question can not be answered yet: when the large language model determines that the content in the currently determined at least one candidate page is insufficient to answer the target question text, that is, the content in the at least one candidate page is still inadequate to fully answer the question, and the output result of the large language model is the second identifier and second content. As described above, the second identifier is used to identify that the content in the at least one candidate page is insufficient to answer the target question text. The second content includes at least two sub-question texts corresponding to the target question text, and the at least two sub-question text corresponds to sub-steps for answering the target question text respectively.

According to some embodiments, the first content further includes first inference information, and the first inference information is used to characterize the inference process of the large language model in generating the first identifier and the first content.

Specifically, in the case that the large language model determines that the question can be answered, the generated first identifier may be a binary determination “can be resolved”. At the point, the large language model may further output a specific inference process, that is, demonstrating the correspondence between the target question and relevant page content, and explaining how the answer is derived from these evidence. Subsequently, the large language model generates a final answer as the answer result of the target question. For example, the answer obtained based on a multimodal large language model (MLLM) may be represented as follows:

$$o , r , a = MLLM ( q , \{ {p}_{1} , … , {p}_{K} \} )$$

where, o=1 denotes that the question has been answered, γ denotes the first inference information for characterizing the inference process of the large language model during the result generation, α denotes the answer to the target question q, and p₁, . . . , p_{K} denotes the determined K candidate pages in document D that are most relevant to the target question.

According to some embodiments, the second content further includes second inference information, and the second inference information is used to characterize the inference process of the large language model during the generation of the second identifier and second content.

Specifically, in the case that the large language model determines that it is insufficient to answer the question, the generated second identifier may be a binary determination “cannot be resolved”. In such case, during the inference process, the large language model may not only illustrate the missing information in candidate pages for answering the target question but also structurally segment the original target question to generate at least two sub-question texts, such as two new sub-questions q₁ and q₂, as expanded branch nodes in the inference tree. For example, the answer result obtained based on the multimodal large language model MLLM may be represented as follows:

$$o , r , \{ {q}_{1} , {q}_{2} \} = MLLM ( q , \{ {p}_{1} , … , {p}_{K} \} )$$

where, o=0 indicates that the question has not been answered, r represents the second inference information for characterizing the inference process of the large language model during the result generation, and {q₁, q₂} denotes the two segmented sub-questions.

Through the above implementation, the large language model may dynamically determines, at each step, whether to directly answer the question or further segment the question and continue to perform inference, thereby combining with a tree inference-based framework and enabling a layer by layer, recursive multimodal question answering process.

According to some embodiments, after the large language model generating the second content, the method of the present disclosure may further include: in response to obtaining the second identifier and second content, for each of the at least two sub-question texts, performing the first operations on the sub-question text as a new target question text to obtain the first identifier and first content corresponding to the new target question text, or to obtain the second identifier and second content corresponding to the new target question text; in response to obtaining the first identifier and first content corresponding to each sub-question text of the target question text, generating the answer to the target question text using a large language model based on the first content corresponding to each sub-question text of the target question text.

Specifically, for each segmented sub-question, it can be treated as a new target question, and the above process of determining corresponding candidate pages and performing answer inference based on the candidate pages and the large language model can be performed.

In some embodiments, after all the sub-questions have been answered, all relevant information generated during the resolution process for the original target question may be consolidated into a input set for the large language model to generate the final answer. Specifically, let the user-input target question be q, the context set, consisting of all segmented sub-questions of the target question q and inference information and answers corresponding to the sub-questions, be U={(qᵤ, rᵤ, aᵤ)}, u=1,2, . . . to represent the segmented sub-question identifier. Let the large language model (LLM) generates the answer to the original target question based on the inference processes and answers for the sub-questions, that is enabling answer consolidation, as shown below:

$$a = LLM ( q , U )$$

where, a represents the answer to the original target question.

According to some embodiments, the method of the present disclosure further includes: in response to obtaining the second identifier and second content corresponding to the first sub-question text, performing the first operations on each sub-question text of the first sub-question text as a new target question text to obtain the first identifier and first content corresponding to the new target question text, or to obtain the second identifier and second content corresponding to the new target question text; in response to obtaining the first identifier and first content corresponding to each sub-question text of the first sub-question text, generating, based on the first content corresponding to each sub-question text of the first sub-question text, the answer to the first sub-question text using a large language model; and generating, based at least on the answer to the first sub-question text and the answer corresponding to the second sub-question text, the answer to the target question text using a large language model, wherein the first sub-question text is at least one of the at least two sub-question texts corresponding to the target question text, and the second sub-question text is the other sub-question text of the at least two sub-question texts corresponding to the target question text other than the first sub-question text.

Specifically, for each segmented sub-question, it can be treated as a new target question, and the above process of determining corresponding candidate pages and performing answer inference based on the candidate pages and the large language model can be performed. For a particular sub-question, instead of directly outputting the first content, if the second content is output when performing inference using the large language model. That is, each sub-question may also be treated as anew target text for sub-question segmentation (i.e., generating the next layer of nodes of the inference tree), and subsequently the first operations are performed on each segmented sub-question respectively until the corresponding first content is obtained for all the sub-questions, and then the answer consolidation operation described above is implemented to obtain the answer to the original target question.

It is understood that answer consolidation may be implemented, at least based on the answers to the corresponding sub-question texts, using the large language model to generate the answer to the original target question text. In some embodiments, while obtaining the answers to the corresponding sub-question texts, the corresponding inference information is also generated, and at this point, the answer to the original target question text may also be generated, based on the answers to the sub-question texts and the inference information, using the large language model.

According to some embodiments, the method of the present disclosure further includes: generating, based on the target question text and the first content, at least one rewritten question text corresponding to the target question text using a large language model; performing the first operations on each rewritten question text as a new target question text to obtain the first identifier and first content corresponding to each rewritten question text, or to obtain the second identifier and second content corresponding to each rewritten question text; in response to obtaining the first identifier and first content corresponding to each rewritten question text, generating, based on the first content corresponding to each rewritten question text and the first content corresponding to the target question text, new first content corresponding to the target question text using a large language model to obtain the answer to the target question text based on the new first content.

In some examples, for further improving the robustness of document question answering and the diversity of inference paths to explore different approaches for answering the same question, the original target question may also be rewritten by incorporating the contextual inference process U obtained when answering the original target question. Specifically, after obtaining the answer process for one question, the original target question is rewritten using a large language model (LLM). For example, the rewriting may be instructed to preserve the meaning of the target question while eliminating ambiguities therein by incorporating the context of the already answered question. The above process may be represented as follows:

$${q}^{′} = LLM ( q , U )$$

where, q′ denotes the question rewritten after undergoing the contextual inference process for the original target problem.

For example, the original target question is: “According to the article content, among graduates from universities established in Province B in Year A, has anyone won a Nobel Prize?”, and during contextual inference, it is known that the university established in Province B in Year A is actually University C. Thus, the question rewritten using the large language model might be: “Among graduates from University C, has anyone won a Nobel Prize?”

In some embodiments, how many question rewriting operations are performed may be set by the system according to the system requirements, for example, a hyper-parameter r may be used to represent the set number of question rewriting, where r is a positive integer greater than or equal to zero.

Furthermore, for the rewritten question text, it may continue be treated as a new target question to perform the aforementioned process of identifying corresponding candidate pages and performing answer inference based on the candidate pages and the large language model.

In some embodiments, once the rewritten question text has also been answered, all relevant information that is generated in the answering process for the original target question may be uniformly consolidated into one input set for the large language model to generate the final answer. Specifically, let the user input original target question be q, the rewritten question be {q′, . . . , q^{τ}}, and the context set, consisting of the inference information and the answers corresponding to the original target question and the rewritten question, be U. Let the large language model (LLM) generates the answer to the original target question based on the aforementioned inference process and the answer, that is, implementing answer consolidation, as represented below:

$${a}^{*} = LLM ( q , \{ {q}^{′} , … , {q}^{τ} \} , U )$$

where, a* denotes the final answer to the target question.

According to some embodiments, the method of the present disclosure further includes: in response to obtaining the second identifier and second content corresponding to the third question text, performing the first operations on each sub-question text of the third question text as a new target question text to obtain the first identifier and first content corresponding to the new target question text, or to obtain the second identifier and second content corresponding to the new target question text, in response to obtaining the first identifier and first content corresponding to each sub-question text of the third question text, generating, based on the first content corresponding to each sub-question text of the third question text, an answer to the third question text using a large language model; and generating, based at least on the answer to the third question text and the answer corresponding to the fourth question text, the answer to the target question text using a large language model; wherein the third question text is at least one question text of the at least one rewritten question text, and the fourth question text is another question text of the at least one rewritten question text other than the third question text.

Specifically, for each rewritten question text, it can be treated as a new target question, and the above process of determining corresponding candidate pages and performing answer inference based on the candidate pages and the large language model can be performed. For a particular rewritten question text, instead of directly outputting the first content, the second content is output when performing inference using the large language model. That is, each rewritten question text may also be treated as a new target text for sub-question segmentation (i.e. generating the next layer of nodes of the inference tree branch), and subsequently the first operations are performed on the sub-question texts of the rewritten question text respectively until the corresponding first content is obtained for all the sub-questions, and then the answer consolidation operation described above is implemented to obtain the answer to the original target question.

It is understood that answer consolidation may be implemented, at least based on the answer to the rewritten question text, using the large language model to generate the answer to the original target question text. In some embodiments, the corresponding inference information is also generated while obtaining the corresponding answer to the rewritten question text, and at the point, the answer to the original target question text may also be generated, based on the answer to the rewritten question text and the inference information, using a large language model.

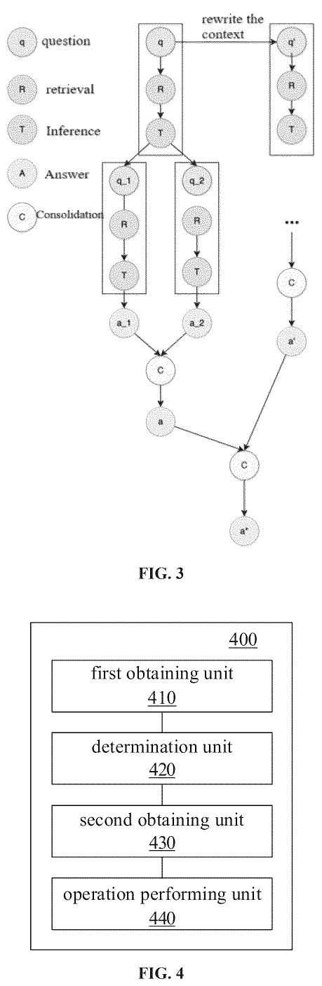

FIG. 3 illustrates a schematic diagram of an inference tree for question answering according to an embodiment of the present disclosure. As shown in FIG. 3, on the basis of a user-provided question q about a specified document D, a tree structure-based question inference algorithm is introduced. The answers of the algorithm forms a tree structure, with question q as the root node of the inference tree. The inference tree contains the following types of nodes: a question node q, which represents a natural language question text, and may be the original user-input question, a contextually rewritten question, or a segmented sub-question. a retrieval node R, whose predecessor is a question node, and the retrieval node R indicates triggering a retrieval process based on the question text, and the retrieval process is used to retrieve at least one candidate page that is most relevant to the question text; an inference node T, whose predecessor is a retrieval node R, and the inference nodes T indicates performing inference using a large language model based on the question text and retrieved candidate pages, and the inference result may be the answer to the question or two sub-questions corresponding to the question; an answer node A, whose predecessor is an inference node, and the answer node indicates the answer to the original question, the rewritten question, or the sub-question; an consolidation node C, which indicates performing consolidation on the answers to multiple sub-questions, or the answer to the rewritten question and the answer corresponding to the original question, to consolidate the final answer to the question.

In some embodiments, the system may maintain an empty first-in-first-out queue to store all unresolved question nodes, and a context set U to store intermediate results (i.e., the first content or the second content) of all questions during processing. And then, the following operational process is performed:
step 1: initializing: upon receiving a question and a document relevant to the question, first initializing an empty queue Q and an empty context set C. The question is added to the queue Q as a question node. The aforementioned page vectorization process is performed on the document.
step 2: obtaining a question: when the queue Q is not empty, retrieving a question node q and process it. If the queue is empty, it indicates that all questions have been answered, proceeding to step 5.
step 3: processing the question node: performing vectorization on the question q and retrieving the top k most relevant candidate pages from the document.
step 4: answering the question: performing answer inference using a large language model based on the retrieved candidate pages. If it is determined that the question can be answered, providing the answer a to the question and proceeding to step 2. If it is determined that it is insufficient to answer the question, generating two sub-questions q1 and q2, adding them to the question queue Q, and proceeding to step 2.
step 5: consolidating answers: completing the consolidation of answers to the sub-questions according to the aforementioned answer consolidation operation for sub-questions.
step 6: rewriting the question: determining the remaining number of times τ that needs to be rewritten currently, if τ=0, proceeding to step 7; otherwise, rewriting the original question by combining the context to obtain a new question q′, adding the new question q′ to the question queue Q, letting τ=τ−1, and proceeding to step 2.
step 7, answer consolidation of multiple inference paths: obtaining, according to the aforementioned answer consolidation operation of the rewritten question, the final answer to the question, and ending the process.

In some embodiments, after determining that the final answer to the original question text is obtained, the final answer is returned to the user, e.g., displaying the final answer via an user interface.

According to embodiments of the present disclosure, hierarchical segmentation and stepwise answering of a question is implemented through an inference tree, and it can be dynamically determined whether to directly answer the question or segment the question into sub-questions for further retrieval, thereby ensuring the logic and planning of the inference processes, and avoiding the robustness deficiencies and error propagation in traditional methods caused by single process or disordered iterations. Furthermore, operations of rewriting the original question based on the context of the inference process and obtaining the final answer through answer consolidation are introduced to the inference process, the former operation disambiguates and rewrites the original question by combining the context to make the question representation more clear and specific, and the latter operation performs unified organization and comprehensive inference on all sub-question answers and evidence to ensure the final answer, the multiple inference paths and the intermediate answers during the inference are more accurate.

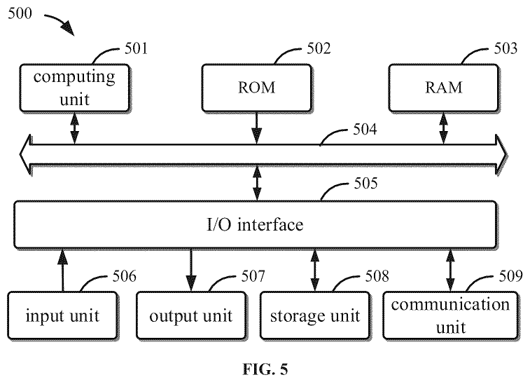

According to embodiment of the present disclosure, as shown in FIG. 4, a large model-based question answering apparatus 400 is provided, including: a first obtaining unit 410, configured to obtain a document for question answering, wherein the document includes at least one page; a determination unit 420, configured to determine a first vector corresponding to each of the at least one page; a second obtaining unit 430, configured to obtain a target question text to be answered to determine a second vector corresponding to the target question text; an operation performing unit 440, configured to perform the following first operations on the target question text: determining, based on the second vector and the first vector corresponding to each of the at least one page, a first similarity between the target question text and each of the at least one page; determining, based on the first similarities, at least one candidate page with the highest similarity to the target question text among the at least one page; and generating, based on at least one candidate page and the target question text, a first identifier and first content, or generating a second identifier and second content, using a large language model. wherein the first content includes an answer corresponding to the target question text, wherein the answer is generated based on the at least one candidate page, and the first identifier is used to identify that the content within the at least one candidate page is sufficient to answer the target question text; wherein the second content includes at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, wherein the at least two sub-question texts are used to obtain the answer to the target question text.

Herein, the operations of the units 410 to 440 of the document-based question answering apparatus 400 are similar to the operations described in steps 210 to 240 above and are details are not repeated herein.

In the technical solution of the present disclosure, the collection, storage, use, processing, transmission, provision, and disclosure of user's personal information are all in compliance with relevant laws and regulations and do not violate public order and good morals.

According to the embodiments of the present disclosure, an electronic device, a computer-readable storage medium, and a computer program product are also provided.

Referring to FIG. 5, a structural block diagram of an electronic device 500 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 5, the electronic device 500 includes a computing unit 501, which may perform various appropriate actions and processing according to a computer program stored in a read-only memory (ROM) 502 or a computer program loaded into a random access memory (RAM) 503 from a storage unit 508. In the RAM 503, various programs and data required by the operation of the electronic device 500 may also be stored. The computing unit 501, the ROM 502, and the RAM 503 are connected to each other through a bus 504. Input/output (I/O) interface 505 is also connected to the bus 504.

A plurality of components in the electronic device 500 are connected to a I/O interface 505, including: an input unit 506, an output unit 507, a storage unit 508, and a communication unit 509. The input unit 506 may be any type of device capable of inputting information to the electronic device 500, the input unit 506 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 507 may be any type of device capable of presenting information, and may include, but are not limited to, a display, a speaker, a video/audio output terminal, a vibrator, and/or a printer. The storage unit 508 may include, but is not limited to, a magnetic disk and an optical disk. The communication unit 509 allows the electronic device 500 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 501 may be a variety of general and/or special purpose processing components with processing and computing capabilities. Some examples of the computing unit 501 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 501 performs the various methods and processes described above, such as the method 200. For example, in some embodiments, the method 200 described above may be implemented as a computer software program tangibly contained in a machine-readable medium, such as the storage unit 508. In some embodiments, part or all of the computer program may be loaded and/or installed onto the electronic device 500 via the ROM 502 and/or the communication unit 509. When the computer program is loaded to the RAM 503 and executed by the computing unit 501, one or more steps of the method 200 described above may be performed. Alternatively, in other embodiments, the computing unit 501 may be configured to perform the method 200 described above by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM) an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component(e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

1. A large model-based question answering method, comprising:
obtaining a document for question answering, wherein the document comprises at least one page;
determining a first vector corresponding to each of the at least one page;
obtaining a target question text to be answered to determine a second vector corresponding to the target question text;
performing the following first operations on the target question text:
determining, based on the second vector and the first vector corresponding to each of the at least one page, a first similarity between the target question text and each of the at least one page;
determining, based on the first similarities, at least one candidate page with the highest similarity to the target question text among the at least one page; and
generating, based on the at least one candidate page and the target question text, a first identifier and first content, or generating a second identifier and second content, using a large language model,
wherein the first content comprises an answer corresponding to the target question text, wherein the answer is generated based on the at least one candidate page, and the first identifier is used to identify that the content within the at least one candidate page is sufficient to answer the target question text;
wherein the second content comprises at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, wherein the at least two sub-question texts are used to obtain the answer to the target question text.

2. The method of claim 1, wherein the first vector is a first vector matrix, and each row or column of the first vector matrix serves as a third vector respectively, wherein each third vector is used to represent at least a part of the page content within the page, wherein determining, based on the second vector and the first vector, the first similarity between the target question text and each of the at least one page comprises:
for each of the at least one page, determining, among all the third vectors corresponding to the page, the third vector with the highest similarity to the second vector, and a second similarity between the third vector with the highest similarity and the second vector; and
determining the first similarity between the target question text and each of the at least one page based on the second similarity respectively.

3. The method of claim 2, wherein the second vector is a second vector matrix, and each row or column of the second vector matrix serves as a fourth vector respectively, wherein each fourth vector is used to represent at least a part of the text content within the target question text, wherein,
determining, based on the second vector and the first vector, the first similarity between the target question text and each of the at least one page comprises:
for each fourth vector in the second vector matrix, determining, among all the third vectors, the third vector with the highest similarity to the fourth vector, and a third similarity between the third vector with the highest similarity and the fourth vector; and
determining, based on the third similarity corresponding to each of the fourth vectors, the first similarity between the target question text and each of the at least one page.

4. The method of claim 1, wherein determining the first vector corresponding to each of the at least one page comprises:
for each of the at least one page, inputting the page image of the page into a pre-trained visual language model to obtain the first vector corresponding to the page.

5. The method of claim 2, wherein determining the first vector corresponding to each of the at least one page comprises: for each of the at least one page, performing the following operations:
segmenting the page into a plurality of page blocks, wherein each of the plurality of page blocks corresponds to at least a part of the page content in the page; and
determining, for each page block, a third vector corresponding to the page block to generate the first vector corresponding to the page based on the third vectors corresponding to the plurality of page blocks.

6. The method of claim 1, wherein obtaining the target question text to be answered to determine the second vector corresponding to the target question text comprises:
inputting the target question text into a pre-trained visual language model to obtain the second vector corresponding to the target question text.

7. The method of claim 3, wherein obtaining the target question text to be answered to determine the second vector corresponding to the target question text comprises:
performing word segmentation on the target question text to obtain a plurality of words corresponding to the target question text;
determining a fourth vector corresponding to each of the plurality of words to generate the second vector corresponding to the target question text based on the fourth vectors corresponding to the plurality of words.

8. The method of claim 1, further comprising:
in response to obtaining the second identifier and second content, for each of the at least two sub-question texts, performing the first operations on the sub-question text as a new target question text to obtain the first identifier and first content corresponding to the new target question text, or to obtain the second identifier and second content corresponding to the new target question text;
in response to obtaining the first identifier and first content corresponding to each sub-question text of the target question text, generating the answer to the target question text using a large language model based on the first content corresponding to each sub-question text of the target question text.

9. The method of claim 8, further comprising:
in response to obtaining the second identifier and second content corresponding to a first sub-question text, performing the first operations on each sub-question text of the first sub-question text as a new target question text to obtain the first identifier and first content corresponding to the new target question text, or to obtain the second identifier and second content corresponding to the new target question text;
in response to obtaining the first identifier and first content corresponding to each sub-question text of the first sub-question text, generating, based on the first content corresponding to each sub-question text of the first sub-question text, the answer to the first sub-question text using a large language model; and
generating, based at least on the answer to the first sub-question text and the answer corresponding to a second sub-question text, the answer to the target question text using a large language model,
wherein the first sub-question text is at least one of the at least two sub-question texts corresponding to the target question text, and the second sub-question text is the other sub-question text of the at least two sub-question texts corresponding to the target question text other than the first sub-question text.

10. The method of claim 1, wherein the first content further comprises first inference information, wherein the first inference information is used to characterize the inference process of the large language model when generating the first identifier and the first content.

11. The method of claim 1, wherein the second content further comprises second inference information, wherein the second inference information is used to characterize the inference process of the large language model when generating the second identifier and the second content.

12. The method of claim 1, further comprising:
generating, based on the target question text and the first content, at least one rewritten question text corresponding to the target question text using a large language model;
performing the first operations on each rewritten question text as a new target question text to obtain the first identifier and first content corresponding to the new target question text, or to obtain the second identifier and second content corresponding to the new target question text;
in response to obtaining the first identifier and first content corresponding to each rewritten question text, generating, based on the first content corresponding to each rewritten question text and the first content corresponding to the target question text, new first content corresponding to the target question text using a large language model, to obtain the answer to the target question text based on the new first content.

13. The method of claim 12, further comprising:
in response to obtaining the second identifier and second content corresponding to a third question text, performing the first operations on each sub-question text of the third question text as a new target question text to obtain the first identifier and first content corresponding to the new target question text, or to obtain the second identifier and second content corresponding to the new target question text;
in response to obtaining the first identifier and first content corresponding to each sub-question text of the third question text, generating, based on the first content corresponding to each sub-question text of the third question text, the answer to the third question text using a large language model; and
generating, based at least on the answer to the third question text and the answer corresponding to a fourth question text, the answer to the target question text using a large language model;
wherein the third question text is at least one question text of the at least one rewritten question text, and the fourth question text is another question text of the at least one rewritten question text other than the third question text.

14. An electronic device, comprising:
a memory storing one or more programs configured to be executed by one or more processors, the one or more programs including instructions for performing operations comprising:
obtaining a document for question answering, wherein the document comprises at least one page;
determining a first vector corresponding to each of the at least one page;
obtaining a target question text to be answered to determine a second vector corresponding to the target question text;
performing the following first operations on the target question text:
determining, based on the second vector and the first vector corresponding to each of the at least one page, a first similarity between the target question text and each of the at least one page;
determining, based on the first similarities, at least one candidate page with the highest similarity to the target question text among the at least one page; and
generating, based on the at least one candidate page and the target question text, a first identifier and first content, or generating a second identifier and second content, using a large language model,
wherein the first content comprises an answer corresponding to the target question text, wherein the answer is generated based on the at least one candidate page, and the first Identifier is used to identify that the content within the at least one candidate page is sufficient to answer the target question text;
wherein the second content comprises at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, wherein the at least two sub-question texts are used to obtain the answer to the target question text.

15. The electronic device of claim 14, wherein the first vector is a first vector matrix, and each row or column of the first vector matrix serves as a third vector respectively, wherein each third vector is used to represent at least a part of the page content within the page, wherein determining, based on the second vector and the first vector, the first similarity between the target question text and each of the at least one page comprises:
for each of the at least one page, determining, among all the third vectors corresponding to the page, the third vector with the highest similarity to the second vector, and a second similarity between the third vector with the highest similarity and the second vector; and
determining the first similarity between the target question text and each of the at least one page based on the second similarity respectively.

16. The electronic device of claim 15, wherein the second vector is a second vector matrix, and each row or column of the second vector matrix serves as a fourth vector respectively, wherein each fourth vector is used to represent at least a part of the text content within the target question text, wherein,
determining, based on the second vector and the first vector, the first similarity between the target question text and each of the at least one page comprises:
for each fourth vector in the second vector matrix, determining, among all the third vectors, the third vector with the highest similarity to the fourth vector, and a third similarity between the third vector with the highest similarity and the fourth vector; and
determining, based on the third similarity corresponding to each of the fourth vectors, the first similarity between the target question text and each of the at least one page.

17. The electronic device of claim 14, the operations further comprising:
in response to obtaining the second identifier and second content, for each of the at least two sub-question texts, performing the first operations on the sub-question text as a new target question text to obtain the first identifier and first content corresponding to the new target question text, or to obtain the second identifier and second content corresponding to the new target question text;
in response to obtaining the first identifier and first content corresponding to each sub-question text of the target question text, generating the answer to the target question text using a large language model based on the first content corresponding to each sub-question text of the target question text.

18. The electronic device of claim 17, the operations further comprising:
in response to obtaining the second identifier and second content corresponding to a first sub-question text, performing the first operations on each sub-question text of the first sub-question text as a new target question text to obtain the first identifier and first content corresponding to the new target question text, or to obtain the second identifier and second content corresponding to the new target question text;
in response to obtaining the first identifier and first content corresponding to each sub-question text of the first sub-question text, generating, based on the first content corresponding to each sub-question text of the first sub-question text, the answer to the first sub-question text using a large language model; and
generating, based at least on the answer to the first sub-question text and the answer corresponding to a second sub-question text, the answer to the target question text using a large language model,
wherein the first sub-question text is at least one of the at least two sub-question texts corresponding to the target question text, and the second sub-question text is the other sub-question text of the at least two sub-question texts corresponding to the target question text other than the first sub-question text.

19. The electronic device of claim 14, the operations further comprising:
generating, based on the target question text and the first content, at least one rewritten question text corresponding to the target question text using a large language model;
performing the first operations on each rewritten question text as a new target question text to obtain the first identifier and first content corresponding to the new target question text, or to obtain the second identifier and second content corresponding to the new target question text;
in response to obtaining the first identifier and first content corresponding to each rewritten question text, generating, based on the first content corresponding to each rewritten question text and the first content corresponding to the target question text, new first content corresponding to the target question text using a large language model, to obtain the answer to the target question text based on the new first content;
in response to obtaining the second identifier and second content corresponding to a third question text, performing the first operations on each sub-question text of the third question text as a new target question text to obtain the first identifier and first content corresponding to the new target question text, or to obtain the second identifier and second content corresponding to the new target question text;
in response to obtaining the first identifier and first content corresponding to each sub-question text of the third question text, generating, based on the first content corresponding to each sub-question text of the third question text, the answer to the third question text using a large language model; and
generating, based at least on the answer to the third question text and the answer corresponding to a fourth question text, the answer to the target question text using a large language model;
wherein the third question text is at least one question text of the at least one rewritten question text, and the fourth question text is another question text of the at least one rewritten question text other than the third question text.

20. A non-transitory computer-readable storage medium storing computer instructions, wherein the computer instructions are used to cause the computer to perform the following operations:
obtaining a document for question answering, wherein the document comprises at least one page;
determining a first vector corresponding to each of the at least one page;
obtaining a target question text to be answered to determine a second vector corresponding to the target question text;
performing the following first operations on the target question text:
determining, based on the second vector and the first vector corresponding to each of the at least one page, a first similarity between the target question text and each of the at least one page;
determining, based on the first similarities, at least one candidate page with the highest similarity to the target question text among the at least one page; and
generating, based on the at least one candidate page and the target question text, a first identifier and first content, or generating a second identifier and second content, using a large language model,
wherein the first content comprises an answer corresponding to the target question text, wherein the answer is generated based on the at least one candidate page, and the first identifier is used to identify that the content within the at least one candidate page is sufficient to answer the target question text;
wherein the second content comprises at least two sub-question texts corresponding to the target question text, wherein the second identifier is used to identify that the content within the at least one candidate page is insufficient to answer the target question text, wherein the at least two sub-question texts respectively correspond to sub-steps for answering the target question text, wherein the at least two sub-question texts are used to obtain the answer to the target question text.
